(19) United States
(12) Patent Application Publication
(10) Pub. No.: US 2013/0060524 A1
(43) Pub. Date: Mar. 7, 2013

(54) Machine Anomaly Detection and Diagnosis Incorporating Operational Data

(71) Applicant: Linxia Liao, Plainsboro, NJ (US)

(72) Inventor: Linxia Liao, Plainsboro, NJ (US)

(73) Assignee: Siemens Corporation, Iselin, NJ (US)

(21) Appl. No.: 13/301,157

(22) Filed: Nov. 21, 2011

Related U.S. Application Data
(60) Provisional application No. 61/418,505, filed on Dec. 1, 2010.

(51) Int. Cl. G06F 15/00

(52) U.S. Cl. 702/184; 702/182; 702/185

(57) ABSTRACT

A method for detecting an anomaly in a machine under test includes monitoring operational data from a control unit of the machine under test. An operational state of the machine under test is identified based on the monitored operational data. Sensor data is monitored from one or more sensors installed within or near to the machine under test. A model corresponding to the identified operational state of the machine under test is consulted to identify one or more key parameters and corresponding normal operating ranges for each determined key parameter. It is determined when a key parameter of the one or more key parameters is not within its corresponding normal operating range based on the monitored sensor data.

### CROSS-REFERENCE TO RELATED APPLICATION

The present application is based on provisional application Ser. No. 61/418,505, filed Dec. 1, 2010, the entire contents of which are herein incorporated by reference.

### BACKGROUND OF THE INVENTION

1. Technical Field

The present disclosure relates to anomaly detection in machines and, more specifically, to machine anomaly detection and diagnosis incorporating operational data.

2. Discussion of Related Art

Condition based maintenance (CBM) is a process for monitoring the condition of machinery, such as machine tools, gas turbines, and high speed trains, so that mechanical problems may be detected and fixed before the machinery breaks down. CBM may be used in a wide variety of machinery of varying complexity from single vehicles to complex automated manufacturing facilities. In implementing CBM, key parameters are identified. Sensors are then installed to monitor the key parameters. A normal operating range may then be determined for each key parameter. When one or more key parameters fall beyond the normal operating range, an alert may be generated to inform maintenance personnel of the potential problem.

While such CBM approaches may be effective in identifying potential problems before serious and costly failures occur, these systems must be highly customized for the particular machinery being monitored. For example, the maintenance personnel must be able to identify the key parameters, must be able to install the right sensors for monitoring the key parameters, and must be able to properly determine when sensor data is indicative of a problem.

Even after such a CBM system has been fully implemented, any change in the operating environment of the machinery under test may compromise the ability of the CBM system to accurately predict problems as the key parameters and normal operating ranges may no longer have diagnostic value. While a new CBM system may be installed or modifications must be made to an existing system to accommodate new key parameters and new normal operating ranges that have been manually identified, this process may be dependent upon expertise, expensive and time consuming.

### SUMMARY

A method for detecting an anomaly in a machine under test includes monitoring operational data from a control unit of the machine under test. An operational state of the machine under test is identified based on the monitored operational data. Sensor data is monitored from one or more sensors installed within or near to the machine under test. A model corresponding to the identified operational state of the machine under test is consulted to identify one or more key parameters and corresponding normal operating ranges for each determined key parameter. It is determined when a key parameter of the one or more key parameters is not within its corresponding normal operating range based on the monitored sensor data.

Determining when the key parameter of the one or more key parameters is not within its corresponding normal operating range may be based on monitored operational data in addition to the monitored sensor data. The one or more key parameters may include a single operational indicator that is calculated from the sensor data and expresses an overall operational condition of the machinery under test and the corresponding normal operating range comprises an acceptable level of deviation from an expected value of the operational indicator. The machine under test may include a machine tool, a gas turbine, or a high-speed train.

The method may additionally include automatically initiating a diagnostic routine to identify a malfunction within the machine under test when it is determined that a key parameter is not within its corresponding normal operating range. The method may additionally include generating an alert when it is determined that a key parameter is not within its corresponding normal operating range.

The operational data may include operating instructions for the machine under test. The operational data may include a desired operational speed or a desired degree of engagement that has been sent to the control unit. Identifying the operational state of the machine under test based on the operational data may include determining which of a set of discrete clusters of data values the operating data falls within.

When the identified operational state of the machine under test has no existing corresponding model, a new model may be generated for the operating state. Generating the model for the corresponding operating may include extracting one or more features from the monitored sensor, identifying one or more key parameters from the extracted one or more features, and determining normal operating ranges for each of the one or more key parameters. Prior to identifying the one or more key parameters, feature selection or feature reduction may be performed on the one or more extracted features.

A system for detecting an anomaly in a machine under test includes a condition based maintenance (CBM) module for receiving machine data or sensor data from one or more sensors installed within or near the machine under test and for receiving operational data from a control module of the machine under test. The CBM module includes an operational state monitoring and determining unit for receiving the operational data from the control module and identifying an operational state of the machine under test based on the operational data, a sensor data monitoring and matching unit for receiving the machine data or sensor data from the one or more sensors and determining when a key parameter of the sensor data is beyond a normal operating range defined for the identified operational state, and a remediation and alert module for taking remedial action or generating an alert when the key parameter of the sensor data is beyond the normal operating range for the identified operational state.

The control module may include a computer numerical control, a control unit with a programmable logic controller (PLC), or a control unit with a human machine interface (HMI).

The remediation and alert module may automatically execute one or more diagnostic utilities for identifying a malfunction in the machine under test when the key parameter of the sensor data is beyond the normal operating range for the identified operational state.

The remediation and alert module may generate a maintenance work order when the key parameter of the sensor data is beyond the normal operating range for the identified operational state.

The operational data may include operating instructions for the machine under test. The operational data may include a desired operational speed or a desired degree of engagement that has been sent to the control unit.

Identifying the operational state of the machine under test based on the operational data may include determining which of a set of discrete clusters of data values the operating data falls within.

The CBM module may additionally include a model generation unit for generating a new model for the identified operating state when no corresponding model exists for the identified operating state. The CBM module may additionally include a feature extraction unit for extracting one or more features from the monitored sensor, identifying one or more key parameters from the extracted one or more features, and determining normal operating ranges for each of the one or more key parameters. The CBM module may additionally include a feature selection/reduction unit for performing feature selection or feature reduction on the one or more extracted features prior to identifying the one or more key parameters.

A computer system includes a processor and a non-transitory, tangible, program storage medium, readable by the computer system, embodying a program of instructions executable by the processor to perform method steps for detecting an anomaly in a machine under test. The method includes monitoring operational data from a control unit of the machine under test, identifying an operational state of the machine under test based on the monitored operational data, monitoring sensor data from one or more sensors installed within or near to the machine under test, calculating an operational indicator for expressing an overall operational condition of the machinery under test from the sensor data, consulting a model corresponding to the identified operational state of the machine under test to identify an expected value of the operational indicator and an acceptable measure of deviation therefrom, determining when the operational indicator is not within the acceptable measure of deviation from the expected value based on the monitored sensor data, and automatically initiating a diagnostic routine to identify a malfunction within the machine under test when it is determined that a key parameter is not within its corresponding normal operating range.

The control unit may include a computer numerical control, a control unit with a programmable logic controller (PLC), or a control unit with a human machine interface (HMI).

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flow chart illustrating an approach for performing machine anomaly detection in accordance with exemplary embodiments of the present invention;

FIG. 2 is a schematic diagram illustrating a system for machine anomaly detection according to exemplary embodiments of the present invention; and

FIG. 3 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention seek to provide a system and method for monitoring machinery, such as machine tools, gas turbines, and high speed trains, to detect anomalies that may be indicative of potential mechanical failure so that maintenance may be implemented prior to mechanical failure.

Exemplary embodiments of the present invention may be able to identify changes in operating conditions of the machinery under test and automatically identify new normal operating ranges for an operating state associated with the identified operating conditions. Where normal operating ranges for the operating state have already been automatically identified, for example, where the machinery under test returns to a previously experienced set of operating conditions, anomaly detection may be performed in accordance with the previously identified normal operating ranges for the previously experienced operating state.

Changes in operating conditions may be identified, for example, by monitoring operational data. The operating conditions may be automatically associated with an operating state, for example, based on a statistical distribution of operating conditions.

As used here, the term “operational data” describes data that is used to control the function of the machinery under test. Operational data may be observed from within a controller of the machinery under test and may include operating instructions for the machinery under test rather than data observed from or derived from the actual operation of the machinery under test. For example, operational data may include a desired operational speed or a desired degree of engagement that has been sent to the controller, for example, from a user or an automated system. Operational data may be control instructions and may represent a desired quantification of function (e.g. a desired drive rate) rather than, for example, an actual state of function for the machinery under test. For this reason, operational data may be obtained from the controller component of the machinery under test.

By continuously or periodically monitoring one or more operational conditions, an operational state of the machinery under test may be determined. In addition to monitoring operational data, exemplary embodiments of the present invention may monitor data from one or more external sensors that have been deployed at various functional elements of the machinery under test. The one or more sensors may be used to monitor one or more key parameters. The key parameters are parameters of operation that are observed from the actual function of the machinery under test, rather than from control instructions, and may be used to determine a manner in which the machinery under test is functioning. The sensor data may also be used in combination with the operational data to determine the manner in which the machinery is functioning. As exemplary embodiments of the present invention may have, for each observed operational state, a corresponding set of key parameters and associated normal operating ranges, exemplary embodiments of the present invention may be able to dynamically switch the criteria by which anomalies are detected based on the determined operational state of the machinery under test. This enhanced flexibility may permit a system for detecting anomalies in machinery, for example, a CBM system, to more easily adapt to changes in operating conditions without the need for complicated intervention on the part of equipment maintenance personnel.

Exemplary embodiments of the present invention may alternatively use the observed sensor data, either alone or in combination with the operational data, in order to distill a single operational indicator. The operational indicator may then be monitored to ensure that it does not deviate from an expected value by more than a predetermined amount. In this respect, the operational indicator may be a single value that is capable of expressing the manner in which the machinery is functioning.

The normal operating ranges for the key parameters and/or the operational indicator may be automatically identified, for example, by collecting sensor data as the machinery under test is being run. It may be assumed, for these purposes, that the machinery under test performs properly while the sensor data is collected for the purpose of establishing normal operating ranges. As normal operating ranges may be determined for a particular operating state, sensor data acquired during one operating state would only be used for determining normal operating ranges for that corresponding operating state and would not be used for determining normal operating ranges for another operating state.

For this reason, determining an operating state may be of particular importance in implementing exemplary embodiments of the present invention. Operating states may be automatically defined by monitoring the operational data and determining when one or more aspects of the operational data sufficiently and abruptly change. Each operating state may be defined as the presence of one or more aspects of operational data falling into a discrete band of values.

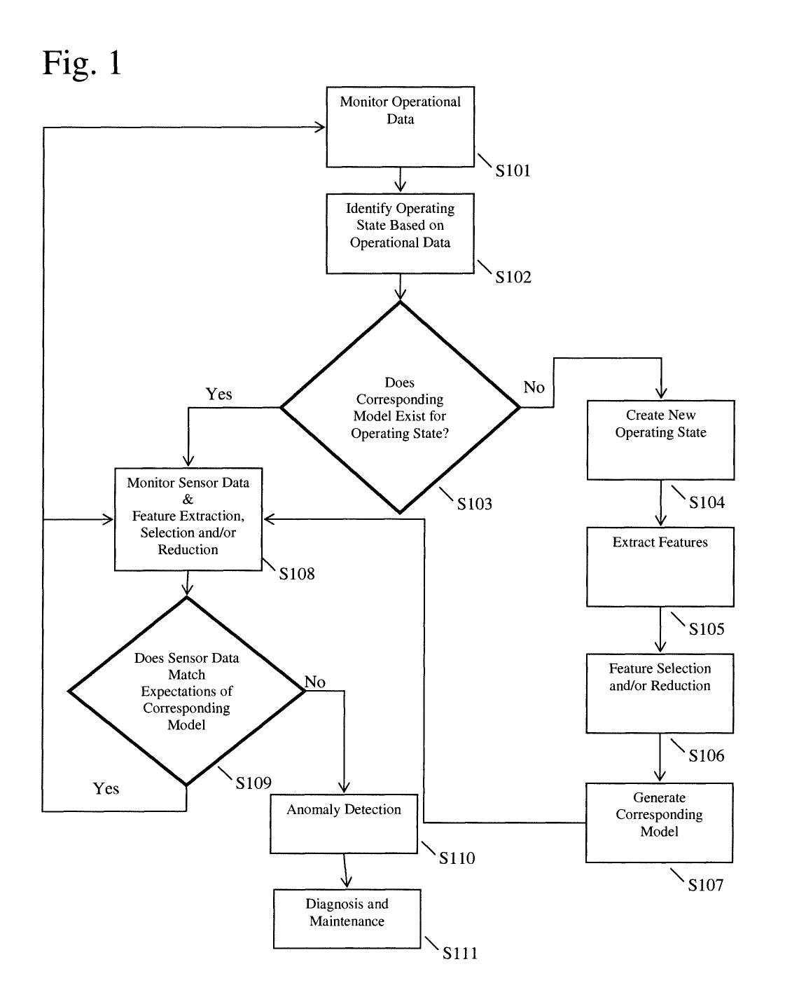

FIG. 1 is a flow chart illustrating an approach for performing machine anomaly detection in accordance with exemplary embodiments of the present invention. First, operational data may be monitored (Step S101). As discussed above, operational data may be data for controlling the function of the machinery under test, as opposed to data observed from the operation of the machinery under test. The operational data may be monitored, for example, from a control module of the machine under test. Next, an operating state may be identified based on the monitored operational data (Step S102). The operating state may either be a previously identified operating state or a new operating state. The operating state may be identified by analyzing the operational data and identifying one or more discrete clusters of data values. Each cluster of values may represent a narrow range of values for operational data. Statistical analysis may be used to analyze the observed distribution of operational data values and define the discrete clusters. The monitoring of the operational data may be ongoing and accordingly the identification of the operating state of the machinery under test may also be ongoing.

Sensor data may also be acquired and acquisition of the sensor data may be ongoing as well. The sensor data may include sensors external to the control module that are installed at various functional elements and collect information pertaining to the actual performance and function of the machinery under test. The sensors may include, for example, temperature sensors, motion sensors, accelerometers, acoustic sensors, stress sensors, chip detectors, humidity sensors, light sensors, pressure sensors, and the like.

It may then be determined whether a model has been defined for the identified operating state (Step S103). Each operating state may have a corresponding model that identifies key parameters and expected values or an operational indicator and an acceptable measure of deviation therefrom. As the model may be automatically defined upon identifying a new operating state, in some cases no corresponding model will exist while in other cases there may already be a corresponding model. Where no corresponding model exists for the given operating state (No, Step S03) then a new operating state may be created (Step S104). Creation of the new operating state may include further monitoring the operational data until adequate data has been collected to properly define the operating state. For example, so that sufficient data may be acquired so that the ordinary range of operating data for the new operating state is well understood. For the new operating state, a set of features may be extracted from sensor data (Step S105). Some features may also be extracted from the operational data, where desired.

Feature extraction may utilize data from one or more sensors, and optionally, from the operational data as well, to derive features that may be of diagnostic value. Data from multiple sensors may be used to produce a single feature and/or multiple features may be derived from a single sensor. There may also be a one-to-one correspondence whereby data from a single sensor is transformed into a single feature. The data from the sensors may be directly utilized as features or one or more transformations may be performed. Transformations include the performance of mathematical algorithms, the use of lookup tables, and time domain analysis, for example, using a fast Fourier transform.

After a set of features has been extracted from the sensor data (Step S105), feature selection and/or reduction may be performed (Step S106). Feature selection may be used to identify one or more features that may be of particular diagnostic value. The features so-identified may be understood to be key parameters for the machinery under test. Feature selection may also be used to eliminate redundancy and/or reduce noise. Where there may be multiple features that provide insight as to an identical mechanical characteristic of the machinery under test, one feature may be selected of the multiple features for the purpose of simplifying data collection and analysis. Feature reduction may be used to transform multiple features into a different feature space in which the multiple features may be represented as a single feature. Feature reduction does not reduce the number of sensors, but rather, projects the original feature space into a new feature space in which different faults/anomalies may be identified more clearly. Feature reduction need not be performed on all features, but may be performed where the opportunity exists.

After one or more key parameters have been identified by feature selection and/or reduction (Step S106), a model corresponding to the identified operating state may be generated (Step S107). Generation of the model may include, for example, analyzing the key parameters over time to determine a baseline. The baseline may be used to establish ranges of normal operation and to identify outlying values that may be beyond expectations for normal operation. The establishment of the normal operating ranges for the various key parameters may be performed using statistical analysis. For example, a sample mean may be calculated for each key parameter and a standard deviation calculated. Outlying values may then be defined, for example, as values extending beyond one, two, or three standard deviations from the mean, or some other predetermined threshold.

Alternatively, generation of the model may include distillation of the one or more key parameters into a single operational indicator that, as described above, may be used to assess the overall operational condition of the machinery under test. Therefore, the operational indicator may function like a health indicator for indicating the health of the machinery. The operational indicator may even be expressed as a single digit number, for example, a floating point variable or a double data type variable, although the operational indicator is not necessarily limited in all embodiments to a single digit integer. Where such an operational indicator is used, the model may define an optimal value for the operational indicator as well as an acceptable level of deviation. Deviation beyond the acceptable level defined in the model may accordingly be indicative of an anomaly.

Once the corresponding model has been generated (Step S107) or in the event that a corresponding model already exists for the identified operating state (Yes, Step S103), the sensor data may be monitored for the purposes of identifying anomalies (Step S108). The monitoring of the sensor data may be ongoing. Monitoring of the sensor data in this step may include both the monitoring of the external sensor data as well as the monitoring of the operational data, although monitoring of the operational data may be an optional step. As the eternal sensor data is monitored, feature extraction, selection, and/or reduction may be performed, for example, to generate an instantaneous observed operational indicator or to otherwise monitor the one or more key parameters.

A determination may then be made as to whether the sensor data matches the expectations of the corresponding model (Step S109). For example, the operational indicator or one or more key parameters may be compared against the corresponding normal operating range(s) as defined in the corresponding model. While the senor data continues to conform to the normal operating range(s) of the corresponding model (Yes, Step S109), the sensor data may continue to be monitored (Step S108) and matched (Step S109). Additionally, the operational data may continue to be monitored (Step S101) to identify when the operating state of the machinery under test may change (Step S102).

If, however, the operational indicator and/or the key parameter(s) derived from the sensor data fail to match the expectations of the corresponding model (No, Step S109), then an anomaly may be detected (Step S110). Upon detection of an anomaly, diagnosis may be performed, either by initiating one or more automatic diagnostic tests or by manual diagnosis (Step S111). Where diagnosis leads to the identification of an actual malfunction, remedial maintenance may be performed.

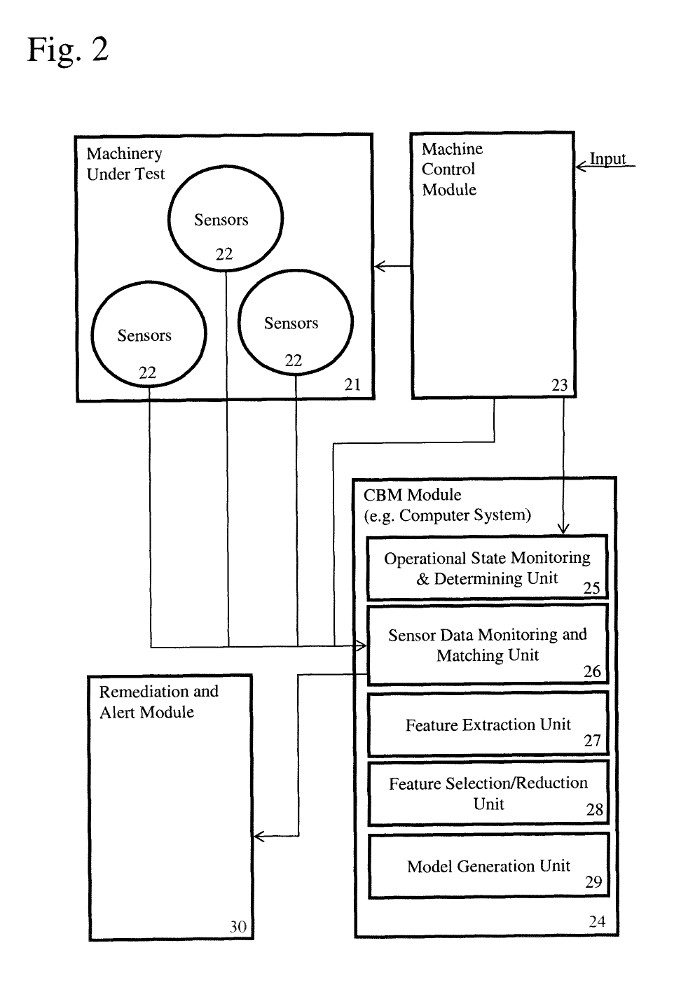

FIG. 2 is a schematic diagram illustrating a system for machine anomaly detection according to exemplary embodiments of the present invention. As described above, the machinery under test 21 may be outfitted with various sensors 22 at one or more key functional elements. The sensors may include, for example, temperature sensors, motion sensors, accelerometers, acoustic sensors, stress sensors, chip detectors, humidity sensors, light sensors, pressure sensors, and the like. For example, a thermocouple may be installed on a functional element of the machinery under test 21 that is prone to overheating in the event of mechanical trouble. For example, a vibration sensor may be installed on a functional element of the machinery under testy 21 that is prone to irregular vibration in the event of mechanical trouble. The selection and placement of the sensors 22 on the various functional elements of the machinery under test 21 may be manually performed in accordance with knowledge about proper operation. The sensors 22 may be installed within and/or near to the machinery under test 21.

Each of the sensors 22 may be connected to a CBM module 24, and in particular, to a sensor data monitoring and matching unit 26. The sensor monitoring and matching unit 26 may receive sensor data from the sensors 22 and operational data and/or machine data from the machine control module 23 and determine whether the received data indicates that the operational indicator and/or one or more key parameters are within the normal operating range for the corresponding operating state. Machine data may include, for example, current, torque, etc. The CBM module 24 may also include an operational state monitoring and detection unit 25 that receives operational data from a machine control module 23. The operational state monitoring and detection unit 25 may monitor the operational data to determine the current operating state, whether it be known or new. The operational data may be derived from input data provided to the machine control module 23. The sensor monitoring and matching unit 26 may be responsible for performing anomaly detection.

The CBM module 24 may also include a feature extraction unit 27 for identifying key parameters from within the received external sensor data. The CBM module 24 may also include a feature selection/reduction unit 28 for selecting and/or reducing features. The CBM module 24 may also include a model generation unit 29 for determining, for each operating state, an operational indicator and/or a set of key parameters and corresponding normal operating range for the operational indicator and/or for the key parameters.

A remediation and alert module 30 may receive an indication from the external sensor data monitoring and matching unit 26 when the sensor data fails to match or otherwise exceeds the expectations of the normal operating range for the corresponding operating state. The remediation and alert module 30 may then generate an alert that an anomaly has been detected and/or may automatically engage remedial action. Remedial action may include, for example, initiation of diagnostic utilities to identify a malfunction and/or generate a maintenance request. The remediation and alert module 30 may either be incorporated into the CBM module 24 or may be distinct from it. For example, the remediation and alert module 30 may be a component of the sensor data monitoring and matching unit.

The CBM module 24 may be implemented, for example, as a computer system including a set of inputs for receiving the sensor data from the various sensors 22 and for receiving the operational data from the machine control module 23. The CBM module 24 may also include various outputs for creating alerts when an anomaly has been detected and/or automatically executing diagnostic utilities for identifying an actual mechanical problem upon detecting an anomaly. Each of the functional units 25-29 may be implemented as an application or function that is executed in the CBM module 24. One or more applications or functions may be used to embody a single functional unit 25-29 and/or multiple functional units 25-29 may be embodied by a single application or function. The CBM module 24 may be embodied by a single computer system or by several computer systems.

As described above, the feature selection/reduction unit 28 may perform feature selection. Feature selection may be implemented by principal component analysis (PCA). Principal component analysis (PCA) is a method for feature selection and dimension reduction. It projects the original dataset X_{N-p} (considering N>P) into a new set of uncorrelated features \tilde{X}_{N-q} with lower dimensions, keeping the largest variance in projected directions according to the largest eigenvalues (γₘ, m=1, 2, . . . , q) of the covariance matrix of original dataset. N is the number of observations. p is the original data dimension and q is the reduced dimension (p>q). It is equivalent to finding a transform matrix Aₚ₋ₐ, that satisfies \tilde{X}=XA, and minimizes the mean square error between X and \tilde{X}. The vectors in \tilde{X} may be called scores. In selecting sensors which contain useful diagnosis information, features contributing the most variance to different scores may be identified. The number of scores (q) may be determined by counting the percentage of variance to the level of 90%. The contribution of the j^{th}(j=1, 2,, . . . , p) feature in the i^{th}, (I=1, 2, . . . , N) observation to the k^{th}, (k=1, 2, . . . , q) score can be calculated as follows:

$${cont}_{ijk} = \frac{{\overline{X}}_{ik}}{{γ}_{k}} {A}_{jk} {X}_{ij} ,$$

If contᵢⱼₖ is negative, it should be set to zero. Hence, the contribution of j^{th} feature for all observations to the k^{th} score can be calculated as:

$${CONT}_{jk} = {\sum }_{i = 1}^{N} {cont}_{ijk} .$$

The plot of CONTⱼₖ for each feature may be the “contribution plot.” The feature which contributes the most to k^{th} score can be determined by:

$$j = arg {max}_{i} ( {CONT}_{jk} ) , j = 1 , 2 , … , p .$$

The features which have the largest contributions may be selected and used as the input to subsequent steps.

As discussed above, the external sensor data monitoring and matching unit 26 may perform anomaly detection. For this purpose, the external sensor data monitoring and matching unit may utilize self-organizing maps (SOM). SOMs are a category of neural network techniques. The term ‘self-organizing’ refers to the ability to learn and organize information without being given the corresponding dependent output values for the input pattern. SOM may provide a way of representing multidimensional feature space in a one- or two-dimensional space while preserving the topological properties of the input space. It may be an unsupervised learning neural network which can organize itself according to the nature of the input data.

Let the p-dimensional input data space be denoted as x=[x₁, x₂, . . . , xₚ]. Neuron j(j=1, 2, . . . , M) in the SOM, where M is the number of neurons, contains a weight vector represented by wⱼ=[wⱼ₁, wⱼ₂, . . . , wⱼₚ]. A best machining unit (BMU) w_{c} may be defined by the neuron whose weight vector is the closest to the input vector x. The distance from x to w_{c} may be given by:

|x−w_{c}|=min{|x−wⱼ|}.

This distance measure may also be called the minimum quantization error (MQE). To train a SOM, the weight vectors may be updated by moving towards the input vectors according to a defined neighborhood kernel function. Similar to neural network, the following learning rule may be applied:

wⱼ(t+1)=wⱼ(t)+β(t)hⱼ(t)(x−wⱼ(t)),

where t is the iteration step, β(t) is the learning rate and hⱼ(t) is the neighborhood kernel function. The training may iterate until a predefined stop criterion is met.

The MQE of a testing vector to a trained SOM may indicate how far away the testing vector deviates from the normal state. MQE may be calculated for every testing vector with a trained SOM as a health indicator for anomaly detection. A T2 control limit may be calculated based on the MQE values in normal condition for anomaly detection. T2 charts may be used for multivariate statistical control area. It may be applied here for single variable MQE as well. For the normal MQE values MQE_{N-1}, let the mean value be denoted by x̅_{MAE} and they covariance by s. The T2 statistics for an input x_{MQE} may be calculated by:

T2=(x_{MQE}− x̅_{MQE})s⁻¹(x_{MQE}− x̅_{MQE}).

The general T2 control limit may be calculated by:

$$T {2}_{limit} = \frac{( N - 1 ) ( N + 1 ) p}{N ( N - p )} {F}_{α} ( p , N - p ) ,$$

where F_{α}(p, M−p) is the 100α % confidence level of F-distribution with p and N−p degrees of freedom. Here p=1. If the T2 statistic of MQE is below the T2 limit, the testing vector may be considered as normal; otherwise an anomaly may be detected. A threshold of MQE may also be tuned, instead of a control limit, to meet the requirements of different applications.

The purpose of diagnosis may be to determine the most likely pattern in the data according to previously observed failure patterns. In contrast to anomaly detection, label information (e.g., knowledge of which data sets corresponded to which failure conditions) may be available when building supervised diagnosis models.

Before building a diagnosis model, the optimal feature space which contributes more than the original feature space in terms of classification rate may be found. Since label information may be available, the Fisher discriminant criterion may be adapted to find projections by maximizing the ratio of the between-class scatter (S_{B}) to the within-class scatter (S_{w}). The goal of the projection may be to maximize the criterion

$$J = \frac{\vert {S}_{B} \vert}{\vert {S}_{W} \vert} .$$

The projected feature space may be used as the input of the supervised SOM diagnosis model.

SOM can be used to learn in a supervised fashion to take label information as part of the input vector, for diagnosis purposes. The supervised SOM model takes the observations and the label information together as the input vectors during the training phase. In the exploration phase, only the observation is presented to SOM and a BMU is selected by minimizing the distance between the observation and the weight vectors in the observation dimensions. The estimation of the label may be computed from the weight vector of the selected BMU in the label coding dimensions. The estimated label may be the predicted label information for diagnosis.

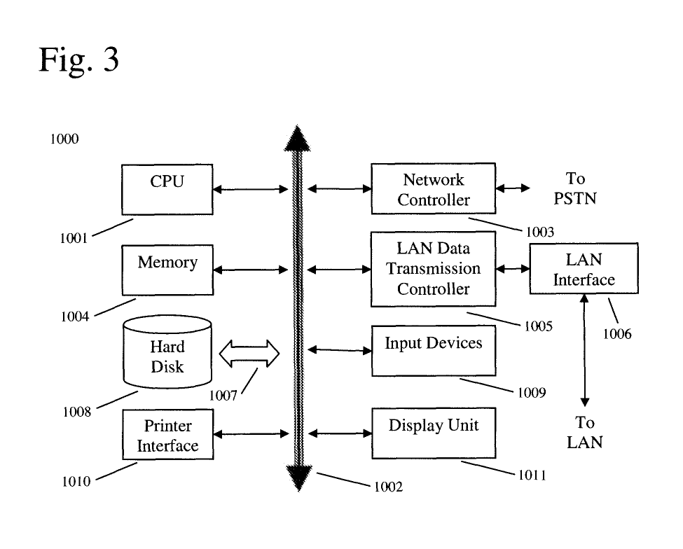

FIG. 3 shows an example of a computer system which may implement a method and system of the present disclosure. The computer system may be used as or included as part of the CBM module 24. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

According to exemplary embodiments of the present invention, operating condition identification may be performed by using the operational data to label the dataset, due to the sparse characteristics of operational data in this case. To automate this process, especially when new operating condition appears, an adaptive method may be implemented. For example, a competitive learning method may be used to dynamically decide whether to update the current clusters of operating conditions or create a new cluster depending on the newly coming operational data. The automation of the process may be able to build new analysis models for newly established operating conditions.

As mentioned above, exemplary embodiments of the present invention may be concerned with aggregation of the diagnosis information obtained from multiple operating conditions. This information fusion may be used to gain reliability in the analysis results using multiple models instead of one model. For example, supervised learning methods such as a regression tree model may be built, using the output of the multiple models as input and the ground truth labels as output, to fuse the output from multiple models.

As discussed above, an operating state may be determined from the operational data. However, other data may also be used to determine the operating state. For example, the weight of various components may also be a meaningful parameter for some applications even it is not directly available from controller. Moreover, data from controller and external sensory data may also be used to identify operating conditions.

Exemplary embodiments of the present invention may also be applied to other areas where operating conditions vary, such as high speed trains running at different speeds and power levels, transformers working at different voltage and current levels, and wind turbines operating at different wind speeds and directions.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for detecting an anomaly in a machine under test, comprising:
monitoring operational data from a control unit of the machine under test;
identifying an operational state of the machine under test based on the monitored operational data;
monitoring sensor data from one or more sensors installed within or near to the machine under test;
consulting a model corresponding to the identified operational state of the machine under test to identify one or more key parameters and corresponding normal operating ranges for each determined key parameter; and
determining when a key parameter of the one or more key parameters is not within its corresponding normal operating range based on the monitored sensor data.

2. The method of claim 1, wherein determining when the key parameter of the one or more key parameters is not within its corresponding normal operating range is based on monitored operational data in addition to the monitored sensor data.

3. The method of claim 1, wherein the one or more key parameters comprise a single operational indicator that is calculated from the sensor data and expresses an overall operational condition of the machinery under test and the corresponding normal operating range comprises an acceptable level of deviation from an expected value of the operational indicator.

4. The method of claim 1, wherein the machine under test comprises a machine tool, a gas turbine, or a high-speed train.

5. The method of claim 1, additionally comprising automatically initiating a diagnostic routine to identify a malfunction within the machine under test when it is determined that a key parameter is not within its corresponding normal operating range.

6. The method of claim 1, additionally comprising generating an alert when it is determined that a key parameter is not within its corresponding normal operating range.

7. The method of claim 1, wherein the operational data includes operating instructions for the machine under test.

8. The method of claim 1, wherein the operational data include a desired operational speed or a desired degree of engagement that has been sent to the control unit.

9. The method of claim 1, wherein identifying the operational state of the machine under test based on the operational data includes determining which of a set of discrete clusters of data values the operating data falls within.

10. The method of claim 1, wherein when the identified operational state of the machine under test has no existing corresponding model, a new model is generated for the operating state.

11. The method of claim 10, wherein generating the model for the corresponding operating state comprises:
extracting one or more features from the monitored sensor;
identifying one or more key parameters from the extracted one or more features; and
determining normal operating ranges for each of the one or more key parameters.

12. The method of claim 11, wherein prior to identifying the one or more key parameters, feature selection or feature reduction is performed on the one or more extracted features.

13. A system for detecting an anomaly in a machine under test, comprising a condition based maintenance (CBM) module for receiving machine data or sensor data from one or more sensors installed within or near the machine under test and for receiving operational data from a control module of the machine under test, the CBM module comprising:
an operational state monitoring and determining unit for receiving the operational data from the control module and identifying an operational state of the machine under test based on the operational data;
a sensor data monitoring and matching unit for receiving the machine data or sensor data from the one or more sensors and determining when a key parameter of the sensor data is beyond a normal operating range defined for the identified operational state; and
a remediation and alert module for taking remedial action or generating an alert when the key parameter of the sensor data is beyond the normal operating range for the identified operational state.

14. The system of claim 13, wherein the control module includes a computer numerical control, a control unit with a programmable logic controller (PLC), or a control unit with a human machine interface (HMI).

15. The system of claim 13, wherein the remediation and alert module automatically executes one or more diagnostic utilities for identifying a malfunction in the machine under test when the key parameter of the sensor data is beyond the normal operating range for the identified operational state.

16. The system of claim 13, wherein the remediation and alert module generates a maintenance work order when the key parameter of the sensor data is beyond the normal operating range for the identified operational state.

17. The system of claim 13, wherein the operational data includes operating instructions for the machine under test.

18. The system of claim 13, wherein the operational data includes a desired operational speed or a desired degree of engagement that has been sent to the control unit.

19. The system of claim 13, wherein identifying the operational state of the machine under test based on the operational data includes determining which of a set of discrete clusters of data values the operating data falls within.

20. The system of claim 13, wherein the CBM module additionally includes a model generation unit for generating a new model for the identified operating state when no corresponding model exists for the identified operating state.

21. The system of claim 20, wherein the CBM module additionally includes a feature extraction unit for:
extracting one or more features from the monitored sensor;
identifying one or more key parameters from the extracted one or more features; and
determining normal operating ranges for each of the one or more key parameters.

22. The system of claim 21, wherein the CBM module additionally includes a feature selection/reduction unit for performing feature selection or feature reduction on the one or more extracted features prior to identifying the one or more key parameters.

23. A computer system comprising:
a processor; and
a non-transitory, tangible, program storage medium, readable by the computer system, embodying a program of instructions executable by the processor to perform method steps for detecting an anomaly in a machine under test, the method comprising:
monitoring operational data from a control unit of the machine under test;
identifying an operational state of the machine under test based on the monitored operational data;
monitoring sensor data from one or more sensors installed within or near to the machine under test;
calculating an operational indicator for expressing an overall operational condition of the machinery under test from the sensor data;
consulting a model corresponding to the identified operational state of the machine under test to identify an expected value of the operational indicator and an acceptable measure of deviation therefrom;
determining when the operational indicator is not within the acceptable measure of deviation from the expected value based on the monitored sensor data; and
automatically initiating a diagnostic routine to identify a malfunction within the machine under test when it is determined that a key parameter is not within its corresponding normal operating range.

24. The system of claim 13, wherein the control unit includes a computer numerical control, a control unit with a programmable logic controller (PLC), or a control unit with a human machine interface (HMI).
